(19) United States
(12) Patent Application Publication
(10) Pub. No.: US 2007/0182379 A1
(43) Pub. Date: Aug. 9, 2007

(54) Container, Battery or Electric Double Layer Capacitor Using the Same, and Electronic Device

(75) Inventors: Yoshiaki Ueda, Higashiomi-shi (JP); Manabu Miyaishi, Higashiomi-shi (JP); Kiyotaka Yokoi, Higashiomi-shi (JP); Nobuyuki Tanaka, Higashiomi-shi (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION

(21) Appl. No.: 11/460,576

(22) Filed: Jul. 27, 2006

(30) Foreign Application Priority Data
Jul. 28, 2005 (JP) P2005-218534
Jul. 25, 2006 (JP) P2006-202160

(51) Int. Cl. H02J 7/00

(52) U.S. Cl. 320/137

(57) ABSTRACT

A container includes a base body constituted of a side wall and a bottom portion, having a hollow or open portion for housing therein an electrical storage element, a conductive layer disposed at a bottom surface of the bottom portion facing the hollow or open portion, a first electrode electrically connected to the conductive layer and led out to an upper surface of the side wall of the base body, and a lid body having on its upper and lower surfaces electrically-connected second electrode and conductive portion. The lid body is bonded to the upper surface of the side wall of the base body to cover the hollow or open portion. The first electrode and the second electrode are substantially flush with each other, thus making it possible to provide a battery or an electric double layer capacitor which can be easily surface-mounted and exhibit an excellent circuit-board productivity.

### BACKGROUND OF THE INVENTION

1. Field of the Invention

The present invention relates to a container designed for use with a rechargeable battery or an electric double layer capacitor, a battery or an electric double layer capacitor that employs the container, and an electronic device. More particularly, the present invention relates to a battery used in electronic apparatuses such as a mobile cellular telephone or an electric double layer capacitor used as a back-up power supply source of a semiconductor memory or a standby power supply source of an electronic apparatus, for example, to a container designed for use with such a battery or capacitor, and to an electronic device on which is mounted the container with the battery or capacitor housed therein.

2. Description of the Related Art

Shown in FIG. 8 is a conventionally proposed low-profile battery F or an electric double layer capacitor F, which is constructed by housing, in an insulative base body, a battery-constituting electrical storage element or an electric double layer capacitor-constituting electrical storage element. The battery-constituting electrical storage element is composed of a positive electrode B-1, a negative electrode B-2, a separator B-3, and an electrolyte B-4, whereas the electric double layer capacitor-constituting electrical storage element is composed of a pair of polarizable electrodes B-1 and B-2, a separator B-3, and an electrolyte B-4.

The battery F or the electric double layer capacitor F of conventional design is constructed by housing, in a container, the positive electrode B-1 or the first polarizable electrode B-1 and the negative electrode B-2 or the second polarizable electrode B-2 having sandwiched therebetween the separator B-3 impregnated with the electrolyte B-4. The container is basically composed of a ceramic base body 11 made of, for example, sintered alumina (Al₂O₃) and a lid body 14 made of a metal material such as an iron (Fe)-nickel (Ni)-cobalt (Co) alloy. A hollow or open portion is formed in the ceramic base body 11 and also a metallized layer 12b is formed at the bottom facing the hollow or open portion. The electrodes B-1 and B-2, the separator B-3 sandwiched between the electrodes B-1 and B-2 are arranged between the metallized layer 12b and the lid body 14, and hermetically sealed in the container. Charging and discharging of the battery F or the electric double layer capacitor F are effected through a first electrode C and a second electrode D formed on the lower surface of the ceramic base body 11 that are connected to the lid body 14 and the metallized layer 12b respectively (for example, refer to Japanese Unexamined Patent Publication JP-A 2004-227959 (pages 4-6, FIG. 1).

However, in the above-described battery F or electric double layer capacitor F of the conventional design, two electrically conductive paths need to be formed inside the ceramic base body 11 by the routing of a metallized layer from the positive electrode B-1 or the first polarizable electrode B-1 to the second electrode D, as well as the routing of a metallized layer from the negative electrode B-2 or the second polarizable electrode B-2 to the first electrode C. This leads to a problem that a complex ceramic base body 11 and a production process of the ceramic base body 11 becomes complicated.

### SUMMARY OF THE INVENTION

The invention has been devised in view of the problems mentioned above, and accordingly an object of the invention is to provide a container that is excellent in productivity, and to provide a high-performance battery or a high-performance electric double layer capacitor that employs the container and is thus surface-mountable onto the electric circuit board with ease, and to provide an electronic device.

The invention provides a container comprising:

a base body constituted of a side wall and a bottom portion, having a hollow or open portion for housing therein an electrical storage element;

an electrically conductive layer disposed on a bottom surface of the bottom portion facing the hollow or open portion;

a first electrode electrically connected to the electrically conductive layer, having a first electrode led-out portion which is led out to an upper surface of the side wall of the base body; and

a lid body having a second electrode formed on its upper surface and an electrically conductive portion formed on its lower surface, the second electrode and the electrically conductive portion being electrically connected to each other,

wherein the lid body is bonded to the upper surface of the side wall of the base body in such a manner as to cover the hollow or open portion.

According to the invention, the lid body has the second electrode formed on its upper surface and the electrically conductive portion formed on its lower surface, and the second electrode and the electrically conductive portion are electrically connected to each other. In this case, the base body only needs to have the first electrode formed thereon as a single-side electrically conductive path, and in contrast to the conventional construction, it is possible to simplify the process of manufacture of the base body. In addition, the routing of wiring from the electrically conductive portion of the lid body to the second electrode can be effected with ease only by connecting the upper surface and lower surface of the lid body. As a result, the container can be made suitable for mass production.

In the invention, it is preferable that the first electrode led-out portion is substantially flush with the second electrode.

In the invention, it is preferable that the first electrode led-out portion is disposed on an upper surface of a projection formed on the upper surface of the side wall of the base body so as to lie in juxtaposition with an opening of the hollow or open portion.

In the invention, it is preferable that the first electrode is connected to the electrically conductive layer by way of a through conductor formed inside the base body with its one end extended to the bottom surface facing the hollow or open portion.

In the invention, it is preferable that the junction between the first electrode and the through conductor is located at some midpoint between the bottom surface facing the hollow or open portion and the lower surface of the base body in the inside of the base body.

The invention provides a battery comprising:

the container mentioned above; and

an electrical storage element housed in the hollow or open portion, composed of a positive electrode, a negative electrode, a separator interposed between the positive electrode and the negative electrode, and an electrolyte,

wherein the lid body is bonded to the upper surface of the side wall of the base body in such a manner as to cover the opening of the hollow or open portion,

wherein one of the positive electrode and the negative electrode is electrically connected to the electrically conductive layer, and the other of the positive electrode and the negative electrode is electrically connected to an electrically conductive portion formed on the lower surface of the lid body.

The invention provides a battery comprising:

a base body constituted of a side wall and a bottom portion, having a hollow or open portion;

an electrically conductive layer disposed on a bottom surface of the bottom portion facing the hollow or open portion;

a first electrode electrically connected to the electrically conductive layer, having a first electrode led-out portion which is led out to an upper surface of the side wall of the base body;

an electrical storage element housed in the hollow or open portion, composed of a positive electrode, a negative electrode, a separator interposed between the positive electrode and the negative electrode, and an electrolyte; and

a lid body having a second electrode formed on its upper surface, the lid body being bonded to the upper surface of the side wall of the base body in such a manner as to cover the hollow or open portion,

wherein one of the positive electrode and the negative electrode is electrically connected to the electrically conductive layer, and the other of the positive electrode and the negative electrode is electrically connected to an electrically conductive portion formed on a lower surface of the lid body.

The invention provides an electric double layer capacitor comprising:

the container mentioned above; and

an electrical storage element housed in the hollow or open portion, the electrical storage element being composed of a first polarizable electrode, a second polarizable electrode, a separator interposed between the first polarizable electrode and the second polarizable electrode, and an electrolyte,

wherein the lid body is bonded to the upper surface of the side wall of the base body in such a manner as to cover the opening of the hollow or open portion,

wherein one of the first polarizable electrode and the second polarizable electrode is electrically connected to the electrically conductive layer, and the other of the first polarizable electrode and the second polarizable electrode is electrically connected to an electrically conductive portion formed on the lower surface of the lid body.

The invention provides an electric double layer capacitor comprising:

a base body constituted of a side wall and a bottom portion, having a hollow or open portion;

an electrically conductive layer disposed on a bottom surface of the bottom portion which bottom surface faces the hollow or open portion;

a first electrode electrically connected to the electrically conductive layer, having a first electrode led-out portion which is led out to the upper surface of the side wall of the base body;

an electrical storage element housed in the hollow or open portion, composed of a first polarizable electrode, a second polarizable electrode, a separator interposed between the first polarizable electrode and the second polarizable electrode, and an electrolyte; and

a lid body having a second electrode formed on its upper surface, the lid body being bonded to the upper surface of the side wall of the base body in such a manner as to cover the hollow or open portion,

wherein one of the first polarizable electrode and the second polarizable electrode is electrically connected to the electrically conductive layer, and the other of the first polarizable electrode and the second polarizable electrode is electrically connected to an electrically conductive portion formed on a lower surface of the lid body.

The invention provides an electronic device comprising:

a wiring substrate having a power source circuit wiring; and

the battery mentioned above, which is mounted onto the wiring substrate,

wherein the first electrode of the container and the second electrode formed on the upper surface of the lid body are connected, so as to face the wiring substrate, to the power source circuit wiring through an electrically conductive.

The invention provides an electronic device comprising:

a wiring substrate having a power source circuit wiring; and

the electric double layer capacitor mentioned above, which is mounted onto the wiring substrate,

wherein the first electrode of the container and the second electrode formed on the upper surface of the lid body are connected to the power source circuit wiring through an electrically conductive material so as to face the wiring substrate.

### BRIEF DESCRIPTION OF THE DRAWINGS

Other and further objects, features, and advantages of the invention will be more explicit from the following detailed description taken with reference to the drawings wherein:

FIG. 1A is a sectional view showing a container according to a first embodiment of the invention; FIG. 1B is a plan view of the container shown in FIG. 1A; and FIG. 1C is an exploded perspective view of the container;

FIG. 2A is a sectional view showing a container according to a second embodiment of the invention; FIG. 2B is a plan view of the container shown in FIG. 2A; and FIG. 2C is an exploded perspective view of the container;

FIG. 3A is a sectional view showing a container according to a third embodiment of the invention; and FIG. 3B is a plan view of the container shown in FIG. 3A;

FIG. 4 is a perspective view showing a container according to a fourth embodiment of the invention;

FIG. 5 is a sectional view showing a container according to a fifth embodiment of the invention;

FIG. 6 is a sectional view showing a container according to a sixth embodiment of the invention;

FIG. 7 is a sectional view showing a container according to an embodiment of the invention with a battery or an electric double layer capacitor mounted onto an electric circuit board; and

FIG. 8 is a sectional view showing an example of a battery or an electric double layer of conventional design.

### DETAILED DESCRIPTION

Now referring to the drawings, preferred embodiments of the invention are described below.

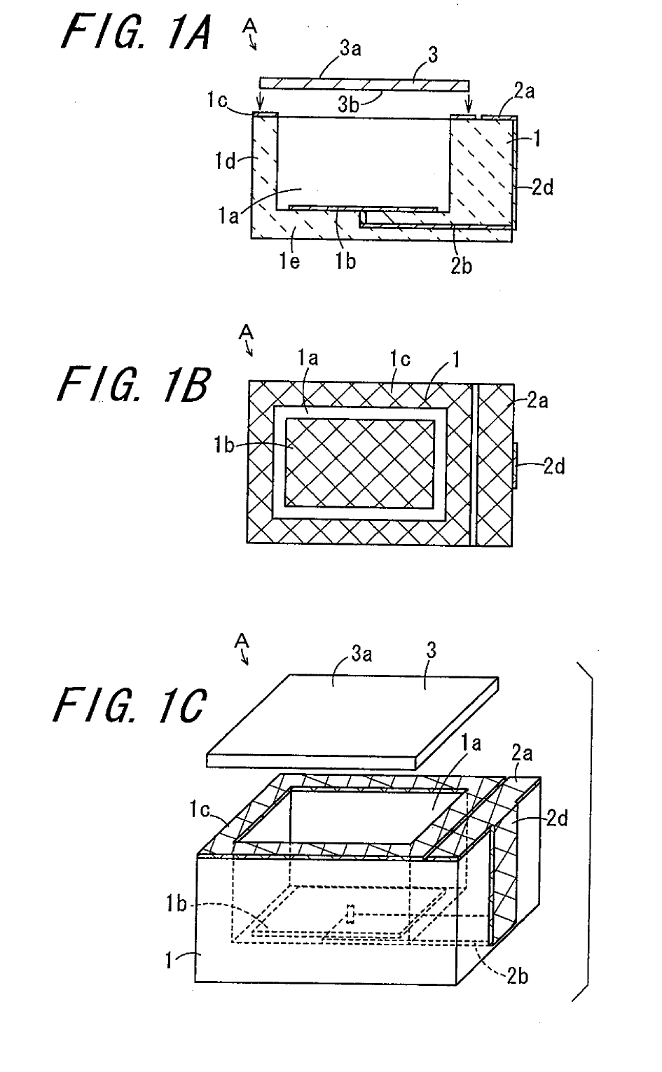

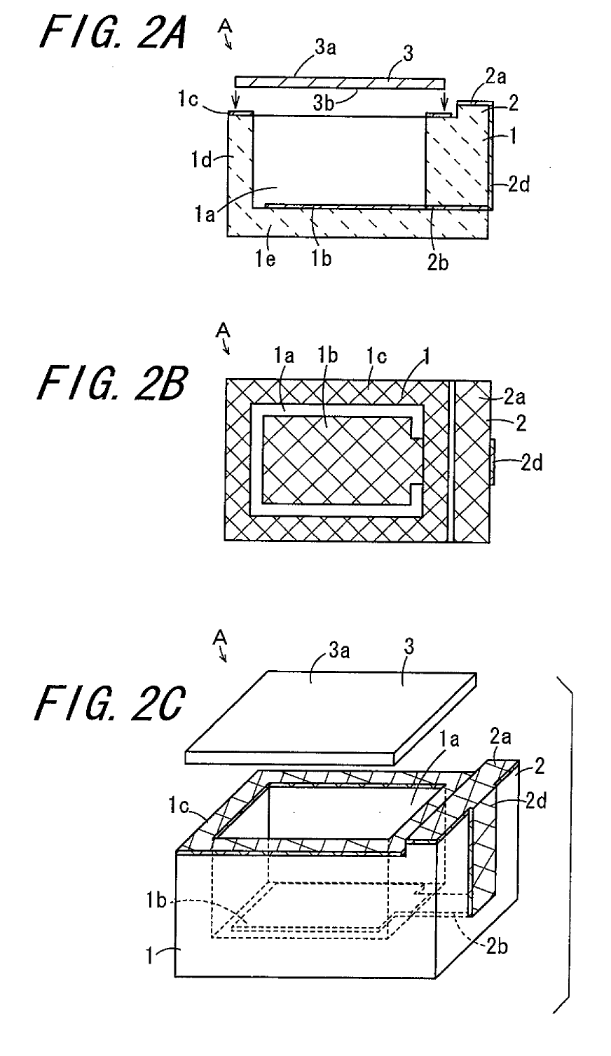

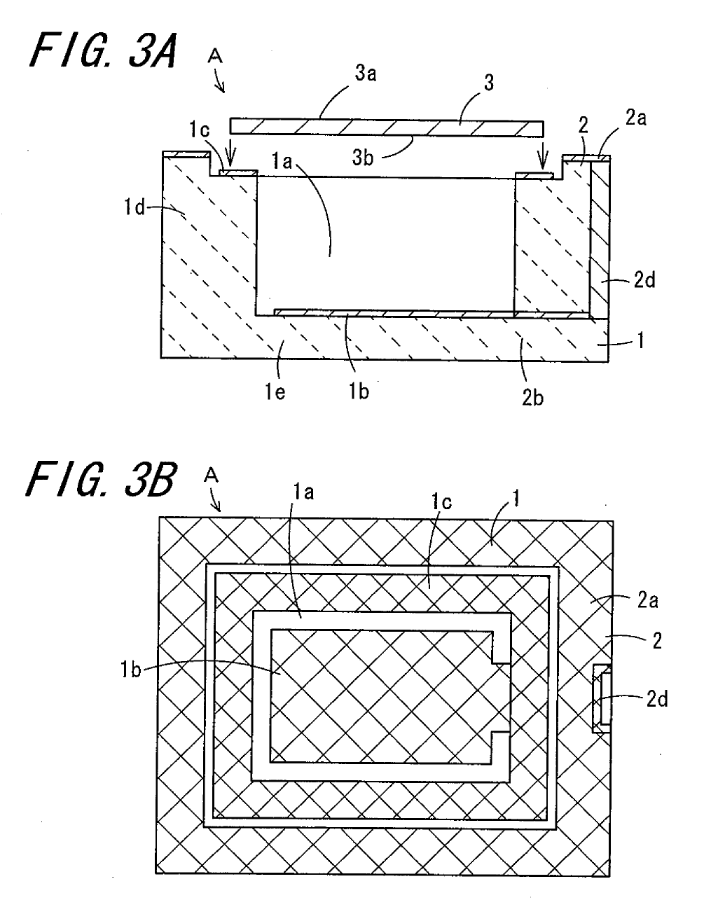

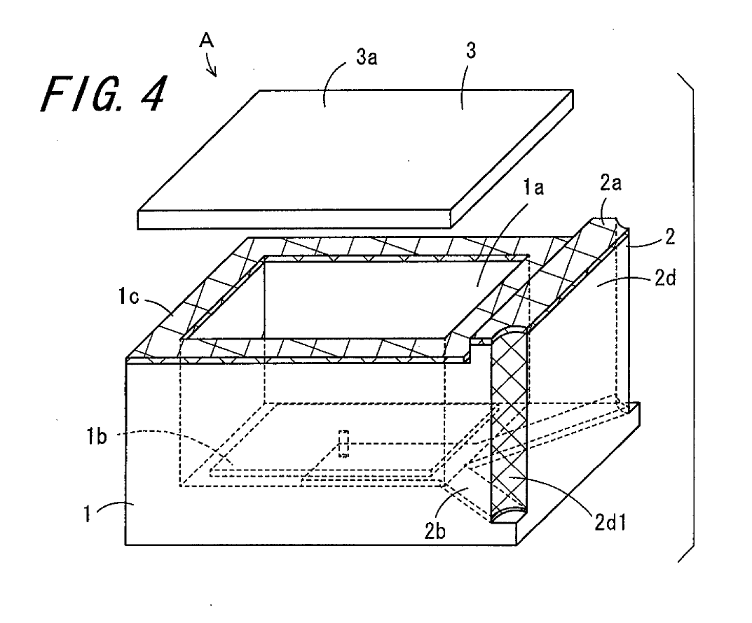

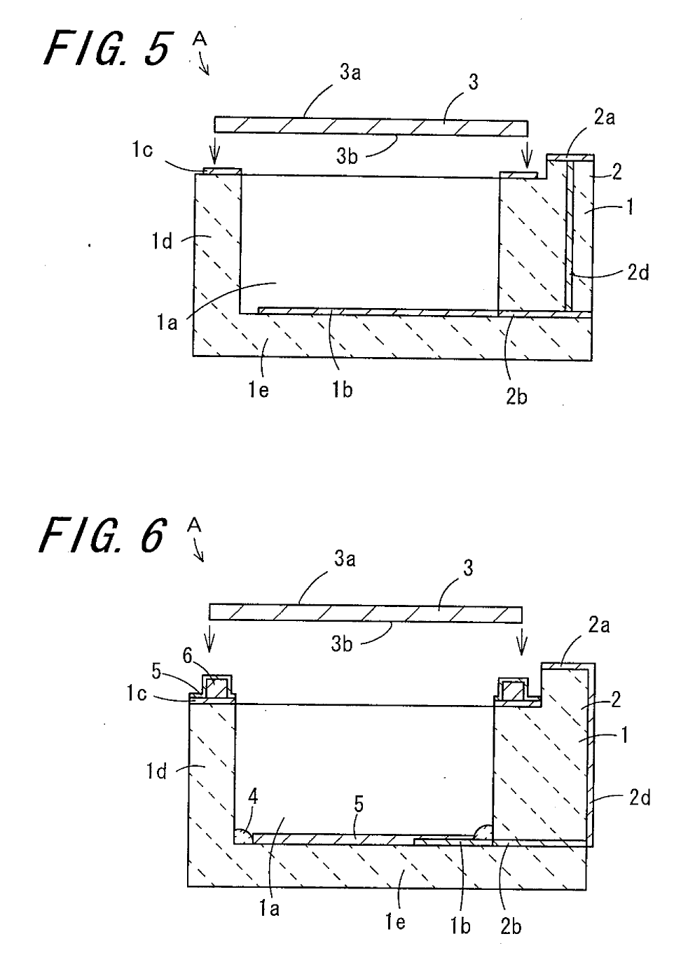

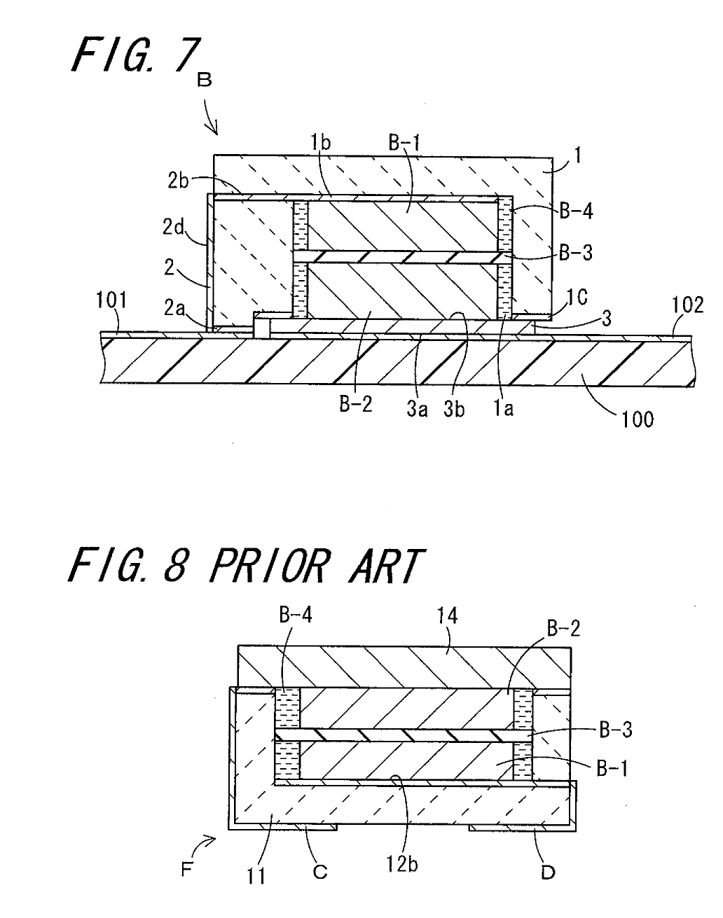

Hereinafter, a detailed description will be given as to a container, a battery or an electric double layer capacitor which employs the container, and an electronic device according to the invention. FIG. 1A is a sectional view showing a container according to a first embodiment of the invention. FIG. 1B is a plan view of the container shown in FIG. 1A. FIG. 1C is an exploded perspective view of the container. FIG. 2A is a sectional view showing a container according to a second embodiment of the invention. FIG. 2B is a plan view of the container shown in FIG. 2A. FIG. 2C is an exploded perspective view of the container. FIG. 3A is a sectional view showing a container according to a third embodiment of the invention. FIG. 3B is a plan view of the container shown in FIG. 3A. FIG. 4 is a perspective view showing a container according to a fourth embodiment of the invention. FIG. 5 is a sectional view showing a container according to a fifth embodiment of the invention. FIG. 6 is a sectional view showing a container according to a sixth embodiment of the invention. FIG. 7 is a sectional view showing a container according to an embodiment of the invention with the battery or the electric double layer capacitor mounted onto an electric circuit board. Note that, for a better understanding of an electrically conductive portion such as a metallized layer of the construction, the areas corresponding thereto are cross-hatched in FIGS. 1B, 1C, 2B, 2C, and 3B. Thus, these cross-hatched areas are not indicative of cross sections.

In the embodiments shown in FIGS. 1A through 1C, FIGS. 2A though 2C, and FIGS. 3A and 3B as well as FIGS. 4 through 7, reference numeral 1 represents a base body formed of an insulative material; reference numeral 1a represents a hollow or open portion for receiving an electrical storage element formed on the base body 1; reference numeral 1b represents an electrically conductive layer formed on a bottom surface facing the hollow or open portion 1a (hereafter referred to as “the first electrically conductive layer”); reference numeral 1c represents a second electrically conductive layer formed in the vicinity of the opening of the hollow or open portion 1a; reference numeral 2d represents a first electrode which has its one end electrically connected to the first electrically conductive layer 1b and its other end led out to the upper surface of a side wall of the base body 1; reference numeral 2b represents a connection conductor of the first electrode 2d; reference numeral 2 represents a projection formed so as to lie in juxtaposition with the opening of the hollow or open portion 1a on the upper surface of the side wall of the base body 1, more specifically, for example, formed at the outer periphery of the upper surface of the side wall of the base body 1 outwardly of the opening of the hollow or open portion 1a; reference numeral 2a represents that part of the first electrode 2d which is led out to the upper surface of the side wall of the base body 1, namely a first electrode led-out portion; reference numeral 3 represents a lid body; 3b represents an electrically conductive portion located on the lower surface of the lid body 3; reference numeral 3a represents a second electrode located on the upper surface of the lid body 3 and electrically connected to the lower electrically conductive portion 3b; reference numeral 4 represents an insulative paste layer; reference numeral 5 represents a protective metal layer; reference numeral 100 represents an external electric circuit board; reference numeral 101 represents a first power source circuit wiring disposed on the external electric circuit board 100; reference numeral 102 represents a second power source circuit wiring disposed on the external electric circuit board 100; reference numeral B-1 represents a positive electrode or a first polarizable electrode; reference numeral B-2 represents a negative electrode or a second polarizable electrode; reference numeral B-3 represents a separator; reference numeral B-4 represents an electrolyte; reference numeral A represents a container of the invention; and reference numeral B represents a battery or an electric double layer capacitor of the invention. Note that, in these figures, the identical components are designated by similar references.

First of all, the container A of the invention will be explained in detail. Referring to FIGS. 1A through 1C for example, the container A of the invention is composed of the base body 1, the first electrically conductive layer 1b, the second electrically conductive layer 1c, and the first electrode 2d, and the lid body 3. The base body 1 is formed of the side wall id and the bottom portion 1e, and has the hollow or open portion 1a for receiving an electrical storage element such as a battery element, an electric double layer capacitor element. In other words, the base body 1 has the side wall 1b which surrounds the bottom surface facing the hollow or open portion 1a of the bottom portion 1e and faces the hollow or open portion 1a. More specifically, the base body 1 includes: the bottom portion 1e having a surface there of which includes the bottom surface facing the hollow or open portion 1a; and the side wall 1d in a frame-like shape installed in a standing manner on an outer periphery of the bottom portion 1e. That is to say, a surface of the bottom portion 1e surrounded by the side wall 1d is called the bottom surface facing the hollow or open portion 1a. The first electrically conductive layer 1b is disposed at the bottom surface facing the hollow or open portion 1a of the bottom portion 1e. The second electrically conductive layer 1c is formed in the vicinity of the opening of the hollow or open portion 1a. The first electrode 2d has its one end electrically connected to the first electrically conductive layer 1b and its other end led out to the upper surface of the side wall 1d of the base body 1 to constitute the first electrode led-out portion 2a. The lid body 3 has the second electrode 3a formed on its upper surface and the electrically conductive portion 3b formed on its lower surface, the second electrode 3a and the lower electrically conductive portion 3b being electrically connected to each other. The lid body 3 is bonded to the upper surface of the side wall 1d of the base body 1, with the second electrically conductive layer 1c lying therebetween, so as to cover the hollow or open portion 1a. The first electrode 2d led-out portion 2a and the second electrode 3a are arranged side by side on the upper part of the container A.

As shown in FIGS. 2A, 2B, and 2C, in the container A of the invention, it is preferable that the projection 2 is formed on the upper surface of the side wall 1d of the base body 1 outwardly of the opening of the hollow or open portion 1a so as to lie in juxtaposition with the opening of the hollow or open portion 1a, that the first electrode 2d led-out portion 2a is formed on the upper surface of the projection 2, and that the first electrode 2d led-out portion 2a is flush with the second electrode 3a.

The base body 1 is made of an insulative material such as ceramic, glass, and resin. The preferred examples thereof include sintered Al₂O₃, sintered mullite (3Al₂O₃.2SiO₂), sintered aluminum nitride (AlN), glass ceramic, liquid crystal polymer, modified polyamide, nylon resin, polyethylene terephthalate, polypropyrene, polyphenylene sulfide, and so on. In the case of forming the base body 1 with use of sintered Al₂O₃, it is formed as follows. At the outset, suitable organic binder, solvent, and the like agent are admixed in a powdery raw material such as aluminum oxide (Al₂O₃), silicon dioxide (SiO₂), magnesium oxide (MgO), calcium oxide (CaO) to obtain an insulative paste in the form of slurry. The insulative paste is formed into ceramic green sheets (a ceramic green sheet will hereafter be also referred to simply as “a green sheet”) by means of doctor blade method or calender rolling method. The ceramic green sheet is cut to a predetermined size. After that, among the ceramic green sheets, a plurality of selected ones are subjected to an appropriate stamping process to create the hollow or open portion 1a and the projection 2. In the following description as to the embodiments of the invention, the base body 1 will be illustrated as a ceramic-made construction. Note that the ceramic-made base body 1 may be formed into the same shape in a case where the other insulative material than sintered Al₂O₃ is used.

The base body 1 and the hollow or open portion 1a, for example, are not limited to a rectangular parallelepiped shape as shown in FIGS. 1A and 1B, but may be of another shape such as a polygonal prism, a circular cylinder. Also in terms of contour, the base body 1 is not limited to a rectangular parallelepiped shape, but may be of a polygonal prism or a circular cylinder.

The base body 1, when made of ceramic, is impervious to the electrolyte B-4 which contains an organic solvent, an acid, etc. Accordingly, it never occurs that impurities eluted from the base body 1 find their way into the electrolyte B-4, and thus the electrolyte B-4 hardly suffers from quality degradation. In the end, the container A constructed with use of ceramic will succeed in maintaining satisfactory battery performance. Alternatively, in the case of forming the base body 1 with use of sintered AlN, the base body 1 exhibits high thermal conductivity. This makes it possible to dissipate heat generated during operation to the outside in an efficient manner, and thereby prevent the electrolyte B-4 from being thermally denatured. Accordingly, the container A can be made highly reliable. Also in the case of constructing the container A with use of another insulative material such as resin, so long as the resin material is highly resistant to corrosion by the electrolyte B-4, high reliability can be attained.

Moreover, since the electrolyte B-4 is housed in the base body 1 made of a material that is excellent in hermeticity and heat resistance such as ceramic, even if the base body 1 is subjected to a temperature cycling test, it never occurs that a detachment is developed in the base body 1 and a bonded part between the base body 1 and the lid body 3 that will eventually cause a leakage of the electrolyte B-4. Further, with the excellent hermeticity of the base body 1, it is possible to prevent the intrusion of water, oxygen, or the like element, which causes battery performance degradation, into the electrolyte B-4 effectively.

Following the stamping process, a metal paste predominantly composed of powdery metal having a high melting point, such as tungsten (W), molybdenum (Mo), manganese (Mn) is print-coated onto predetermined areas of the green sheets. That is to say, onto these predetermined areas of the green sheets is print-coated the metal paste which constitutes the first electrically conductive layer 1b, the second electrically conductive layer 1c, and the first electrode 2d including the connection conductor 2b for providing electrical connection between the first electrically conductive layer 1b and the first electrode 2d led-out portion 2a. The second electrically conductive layer 1c is created in a case where the lid body 3 and the base body 1 are bonded together with use of a brazing filler metal. In this case, the second electrically conductive layer 1c needs to be spaced a certain interval away from the first electrode 2d led-out portion 2a. On the other hand, in a case where the lid body 3 and the base body 1 are bonded together with use of a resin adhesive for instance, the formation of the second electrically conductive layer 1c may be omitted. Note that the second electrically conductive layer 1c is not intended for passing electric current therethrough. However, when formed of a metallized layer, the second electrically conductive layer 1c possesses electrical conductivity, and is thus identified by the name.

Subsequently, a plurality of the green sheets to be formed into the base body 1 are brought into intimate contact with one another under a pressure of 4 to 5 MPa at a temperature of approximately 85° C. in advance of a firing process. At this time, as shown in FIG. 6, it is desirable to apply the insulative paste layer 4 in a manner such that the outer edge of the bottom surface facing the hollow or open portion 1a will be coated with the insulative paste layer 4. The insulative paste layer 4 is predominantly composed of Al₂O₃. In this case, the side wall 1d of the base body 1 and the surface of the bottom portion 1e of the hollow or open portion 1a constitute an ideal hermetic structure, wherefore the hollow or open portion 1a can be hermetically sealed without fail. This makes it possible to prevent the electrolyte B-4 contained in the hollow or open portion 1a from leaking to the outside effectively.

Lastly, the green sheet stacked body thus obtained is fired in a reduction atmosphere at a temperature of approximately 1600° C., whereupon the base body 1 is fabricated. The base body 1 constitutes a principal portion of the container A of the invention.

The configuration of the projection 2 can be either the one as shown in FIGS. 2A, 2B, and 2C or the one as shown in FIGS. 3A and 3B. In the former, the projection 2 is formed saliently at one end of the outer periphery of the upper surface of the side wall 1d defining the opening of the hollow or open portion 1a of the base body 1. In the latter, the projection 2 is formed saliently throughout the outer periphery of the side wall 1d defining the opening of the hollow or open portion 1a of the base body 1. The area of the upper surface of the projection 2 may be determined arbitrarily so long as at least the first electrode 2d led-out portion 2a formed thereon is mechanically and electrically connected to the electric circuit board in an appropriate manner.

It is particularly preferable that, as shown in FIGS. 3A and 3B, the projection 2 is formed saliently throughout the outer periphery of the side wall 1d defining the opening of the hollow or open portion 1a. With this configuration, the lid body 3 is entirely surrounded by the projection 2. Therefore, at the time of mounting the container A of the invention with the battery B or the electric double layer capacitor B onto the electric circuit board 100, the side surfaces of the lid body 3 are not left exposed. This makes it possible to avoid occurrence of electrical short circuit between the lid body 3 and an electronic component, for instance (not shown in the figure) to be mounted onto the electric circuit board 100 without fail. In a case where the first electrode 2d is negative in polarity, by setting the negative-side potential at ground potential, it is possible to avoid occurrence of electrical short circuit without fail. Moreover, the projection 2 and the first electrode 2d led-out portion 2a formed on the upper surface of the projection 2 are so disposed as to surround the lid body 3. Accordingly, at the time of bonding the container A to the electric circuit board 100 by means of soldering, the surface tension of a solder material in use is exerted uniformly. This helps prevent the container A from being positionally deviated from a predetermined mounting location.

As another advantage, at the time of mounting the container A of the invention with the battery B or the electric double layer capacitor B onto the electric circuit board 100, as large a contact area as possible can be secured between the first electrode 2d led-out portion 2a formed on the upper surface of the projection 2 and the power source circuit wiring 101, 102 of the electric circuit board 100. Accordingly, the battery B or the electric double layer capacitor B can be fixedly emplaced on the electric circuit board 100 with stability.

The first electrode 2d is created as follows. Following the completion of formation of the green sheet stacked body which is formed into the base body 1, a metal paste prepared for forming the first electrode 2d is print-coated onto the green sheet stacked body by means of screen printing in a manner such that the first electrode 2d will extend from the side surface of the green sheet stacked body to the upper surface of the projection 2. Alternatively, as shown in FIGS. 3A and 3B, the first electrode 2d may be made partly in the form of a so-called castellation conductor by imparting a castellated configuration to the side surface of the side wall 1d of the green sheet stacked body which is formed into the base body 1. In this case, a through hole is bored in the corresponding green sheet to create a castellation, and then a metal paste composed predominantly of powdery metal having a high melting point such as W, Mo, Mn is applied to the inner surface of the through hole by means of suction printing. After that, an unnecessary portion of the green sheet is cut away in a manner such that the through hole is sectioned in a vertical direction. In this way, the castellation conductor is obtained.

Note that a part of the first electrode 2d which is located on the side surface of the side wall 1d of the base body 1 may be divided into a plurality of portions. For example, instead of forming the castellation conductor 2d at the midportion of one side surface of the side wall 1d of the base body 1 as shown in FIG. 3B, it is possible to create, as shown in FIG. 4, two pieces of the castellation conductors at both corners of the one side surface. By forming a plurality of castellation conductors in that way, it is possible to establish electrical connection between the first electrically conductive layer 1b and the first electrode led-out portion 2a with high reliability.

Moreover, as shown in FIGS. 1A through 1C as well as FIG. 4, the connection conductor 2b of the first electrode 2d may be made in the form of a through conductor which is formed inside the base body 1, with its one end extended to the bottom surface facing the hollow or open portion 1a. In this case, the first electrically conductive layer 1b is connected to the one end of the through conductor (the connection conductor 2b). The through conductor is formed as follows. After a through hole is created in the corresponding green sheet, a metal paste composed predominantly of powdery metal having a high melting point such as W, Mo, Mn is applied to the inner surface of the through hole by means of suction printing. Then, firing is carried out, whereupon a metallized conductor acting as the through conductor is formed. Note that the through conductor is not limited to such a metallized conductor, but may be of another configuration. For example, the through conductor may be formed by filling in the through hole an uncured resin material blended with electrically conductive powder (electrically conductive paste). Also in this case, needless to say, the connection conductor (through conductor) 2b may be divided into a plurality of portions.

The through conductor may be so formed as to extend from the bottom surface facing the hollow or open portion 1a to the lower surface of the base body 1. In this case, however, the electrically conductive portion is exposed on the lower surface of the base body 1. Therefore, it is preferable that the connection conductor 2b is composed of a combination of a through conductor and an inner-layer conductor. The first electrode 2d is configured so as to lead out to the upper surface of the side wall 1d of the base body 1 by way of the through conductor and the inner-layer conductor located between the bottom surface facing the hollow or open portion 1a and the lower surface of the base body 1 in the inside of the base body 1. That is, the through conductor extends internally in the base body 1; to be more specific, internally in the bottom portion 1e, from the lower surface of the first electrically conductive layer 1b to some midpoint between the bottom surface facing the hollow or open portion 1a and the lower surface of the base body 1, and in turn the inner-layer conductor extends therefrom to the side surface of the base body 1. By doing so, the connection conductor 2b of the first electrode 2d is so formed as not to pass through a region between the side wall 1d and the bottom portion 1e (the bottom and side surfaces facing the hollow or open portion 1a) of the base body 1. Accordingly, the ceramic stacked body is less prone to peeling off in the attached region between the side wall 1d and the bottom portion 1c of the base body 1 because the electrically conductive layer is not formed therearound. This makes it possible to simplify the configuration of the insulative paste layer 4 as shown in FIG. 6. As another advantage, in a case where the through conductor has its upper surface covered with the first electrically conductive layer 1b, and the through conductor is kept out of contact with the electrolyte B-4 and therefore becomes impervious to the electrolyte B-4.

It is preferable that the first electrically conductive layer 1b, the second electrically conductive layer 1c, the first electrode 2d, and the first electrode 2d led-out portion 2a, each of which is formed in the base body 1, have their exposed surfaces plating with a layer of a metal material which is highly corrosion resistant and exhibits excellent wettability with respect to solder, to be more specific, a 1 to 12 μm-thick Ni layer. This makes it possible to protect each of the conductor portions in metallized form from oxidative corrosion, as well as to avoid elution of metal substances from the conductor portions.

If the thickness of the Ni layer is less than 1 μm, it becomes difficult to protect the conductor portions in metallized form from oxidative corrosion, as well as to avoid elution of metal substances from the conductor portions. As a consequence, the battery or the electric double layer capacitor is liable to deliver poor performance capabilities. By way of contrast, if the thickness of the Ni layer is greater than 12 μm, much time needs to be spent in applying the Ni-layer coating, thus causing a decrease in mass-productivity and an increase in electrical resistance.

It is more preferable that on the aforementioned Ni layer is additionally formed a 0.3 to 5 μm-thick, gold (Au)-made metal layer by means of plating or the like method. This makes it possible to enhance the wettability with respect to solder, as well as to avoid oxidative corrosion.

If the thickness of the Au layer is less than 0.3 μm, it becomes difficult to make the Au layer uniform in thickness. As a consequence, the Au layer is made unduly thin in part, or the Ni layer is liable to have an Au layer-absent part, thus lowering the effect of preventing oxidative corrosion and the wettability with respect to solder. By way of contrast, if the thickness of the Au layer is greater than 5 μm, much time needs to be spent in applying the Au plating layer, thus causing a decrease in mass-productivity.

The first electrically conductive layer 1b, although it is illustrated as being formed as a metallized layer, may be designed in another form so long as it is able to function as an electrical conductor which is resistant to corrosion by the electrolyte B-4. For example, the first electrically conductive layer 1b may be formed either by depositing a metal material which is resistant to corrosion by the electrolyte B-4, such as aluminum (Al), directly onto the bottom surface facing the hollow or open portion 1a by means of vapor deposition, or by coating an electrically conductive paste layer composed of an anti-corrosion resin material blended with electrically conductive particles onto the bottom surface facing the hollow or open portion 1a. Thus constructed, the first electrically conductive layer 1b is allowed to function as one current collector.

The application of the Au plating layer is especially advantageous if it is made on the surfaces of the first electrically conductive layer 1b and the second electrically conductive layer 1c formed inside the container A. That is, being impervious to the acidic electrolyte B-4, the Au plating layer serves to effectively prevent a major metal constituent of the first electrically conductive layer 1b as well as the second electrically conductive layer 1c, such as W, from dissolving easily into the electrolyte B-4 under the influence of a voltage produced in accompaniment with charging and discharging operations. Moreover, the Ni layer and the Au plating layer on the first electrode 2d serve to enhance the wettability with respect to solder, wherefore the strength of bonding between the first electrode 2d and the power source circuit wiring disposed on the surface of the electric circuit board (not shown in the figure) can be increased.

In the base body 1 thus constructed, the lid body 3 is bonded to the second electrically conductive layer 1c so as to cover the hollow or open portion 1a hermetically. In the lid body 3, at least the midportion of its lower surface is made to exhibit electrical conductivity to form the electrically conductive portion 3b, and on the upper surface thereof is formed the second electrode 3a which is electrically connected to the electrically conductive portion 3b. Note that, instead of forming the second electrically conductive layer 1c, it is possible to use a resin adhesive or the like to achieve bonding between the lid body 3 and the base body 1.

The lid body 3 is constructed by applying an electrically conductive material to the surface of a metal base such as Fe—Ni—Co alloy, Fe—Ni alloy, Al, or a ceramic base such as sintered Al₂O₃, sintered AlN, glass ceramic.

In the lid body 3 made of metal, the lower electrically conductive portion 3b and the upper electrode led-out portion are rendered electrically conductive so that the lid body 3 is able to function as intended. It is preferable that the lid body 3 has its surface plating with a protective layer such as an Ni layer, an Au layer, an Al layer. In order to bring the lid body 3 out of electrical contact with the first electrode 2d led-out portion 2a, the lid body 3 is bonded to the base body 1 in a manner such that its outer periphery is spaced a certain interval away from the projection 2. The separation between the lid body 3 and the first electrode led-out portion 2a is achieved by creating a spacing between the lid body 3 and the first electrode 2d at the time of bonding, or by placing an insulating member such as a resin plate therebetween.

In the lid body 3 made of metal, further, one side surface and part of the upper surface thereof that are close to the first electrode 2d led-out portion 2a may be subjected to insulation treatment. In this case, the lid body 3 can be bonded to the upper surface of the base body 1 without the necessity of spacing apart the lid body 3 and the first electrode 2d led-out portion 2a. Examples of the insulation treatment include formation of an insulating layer with use of resin. In the case of forming a resin-made insulating layer on the aforementioned part of the upper surface of the lid body 3, it is preferable that the electrically conductive second electrode 3a located on the upper surface of the lid body 3 is made substantially equal in area to the first electrode 2d led-out portion 2a. In this case, at the time of bonding the container A to the electric circuit board 100 by means of soldering, the surface tension of solder corresponding to the second electrode 3a and that corresponding to the first electrode led-out portion 2a are kept in balance. This helps prevent the container A from being positionally deviated from a predetermined mounting location.

On the other hand, in the lid body 3 made of ceramic, in that part thereof which provides electrical connection between the electrically conductive portion 3b and the second electrode 3a is formed a metallized layer made of W, Mo, Mn, or the like material, or formed a metal thin layer, such as an Al layer, by means of sputtering or=vapor deposition. In this case, on the surface of the lid body 3 made of sintered Al₂O₃, for example, is formed a metallized layer made of metal having a high melting point such as W, Mo, Mn. Moreover, in order to establish electrical connection between the electrically conductive portion 3b and the second electrode 3a, the electrically conductive portion 3b and the second electrode 3a are connected to each other by a through conductor or an electrically conductive path. The electrically conductive path is so formed as to extend from the electrically conductive portion 3b through the side surface of the lid body 3 to the second electrode 3a by applying a metal layer such as a metallized layer over the surfaces of the lid body 3.

In this case, the metallized layer formed in the lid body 3 should preferably be analogous to the ones for constituting the first electrically conductive layer 1b, the second electrically conductive layer 1c, and the first electrode 2d. This allows the shared use of a metal paste prepared for use, wherefore the metallized layers can be produced in an efficient manner. Moreover, it is preferable that, like the first electrically conductive layer 1b and the second electrically conductive layer 1c, that part of the metallized layer which lies on the lower surface of the lid body 3 has its surface plating with an Ni layer and according to need, an Au layer on the Ni layer, or plating with Al or the like substance by a conventionally known technique such as a sputtering method, a vapor deposition method. This makes it possible to effectively protect the metallized layer formed on the lower surface of the lid body 3 against corrosion, as well as to impart excellent wettability with respect to a brazing filler material, such as Ag brazing filler, Au-tin (Sn) solder, to the second electrode 3a formed on the upper surface of the lid body 3. As a result, the lid body 3 and the first, second power source circuit wiring 101, 102 of the electric circuit board 100 can be bonded together more firmly.

Thus, the metallized layer or metal thin layer of the lid body 3 is fixed to the second electrically conductive layer 1c of the base body 1 by way of a bonding material such as Al brazing filler, silver (Ag) brazing filler, Ag-copper (Cu) brazing filler, Au-tin (Sn) solder.

It is preferable that, as shown in FIG. 6, a metal frame member 6 is joined to the second electrically conductive layer 1c. The metal frame member 6 is made of Fe—Ni—Co alloy, Fe—Ni alloy, or Al, for example. With this construction, instead of using a bonding material such as brazing filler metal, it is possible to adopt a resistance welding method such as a seam welding method to achieve bonding between the lid body 3 and the base body 1 air-tightly, with the metal frame member 6 lying therebetween. That is, the hollow or open portion 1a can be hermetically sealed with ease by means of resistance welding. In the case of bonding the lid body 3 to the base body 1 through the metal frame member 6, in contrast to the case of achieving the bonding with use of solder or a resin adhesive, the bonding operation can be carried out with an exceptionally high degree of efficiency. As another advantageous effect, even though the base body 1 becomes deformed, the deformation can be accommodated by the metal frame member 6.

Note that the lid body 3 assembly may be composed of a platy ceramic base having formed at its midportion a through hole drilled all the way through from the upper main surface to the lower main surface of the ceramic base. In the through hole is fitted a metal plate. In this case, since the side surfaces of the lid body 3 possess insulation properties, there is no possibility of occurrence of electrical short circuit between one side surface of the lid body 3 and the first electrode led-out portion 2a.

In the container of the invention, if the corrosion resistance of the first electrically conductive layer 1b is found to be insufficient, as shown in FIG. 6, it is preferable that the first electrically conductive layer 1b formed at the bottom surface facing the hollow or open portion 1a has its surface plating with the protective metal layer 5 such as an Al layer by a conventionally known technique such as a sputtering method, a vapor deposition method. In this case, by forming the protective metal layer 5 of a material which is resistant to corrosion by the electrolyte B-4, such as Al, it is possible to protect the first electrically conductive layer 1b against electrolyte B-4-induced corrosion damage. The protective metal layer 5 is allowed to function as a current collector. As a result, the first electrically conductive layer 1b is free from an undesirable rise in electrical resistance, and is also prevented from dissolving into the electrolyte B-4, wherefore the battery B or the electric double layer capacitor B is able to deliver satisfactory performance capabilities for a longer period of time.

It is also preferable that the second electrically conductive layer 1c has its surface plating with a protective metal layer such as an Al layer, too. This makes it possible to render the second electrically conductive layer 1c resistant to corrosion by the electrolyte B-4, wherefore the desired performance capabilities of the battery B or the electric double layer capacitor B can be maintained satisfactorily. Note that, in the embodiments shown in FIGS. 2A through 2C, and FIGS. 3A and 3B as well as FIG. 5, the second electrically conductive layer 1c is sandwiched between the upper surface of the side wall 1d of the base body 1 and the lower surface of the lid body 3 and thus makes little contact with the electrolyte B-4 contained within the hollow or open portion 1a. Accordingly, regardless of the presence or absence of the protective metal layer, the second electrically conductive layer 1c is less prone to electrolyte B-4-induced corrosion damage, wherefore the battery B or the electric double layer capacitor B can be operated without significant degradation of performance capabilities.

In the case of applying a coating of the insulative paste layer 4, the protective metal layer 5 is so formed as to extend over the upper part of the first electrically conductive layer 1b with the insulative paste layer 4 as well as the bottom surface facing the hollow or open portion 1a. In addition, the protective metal layer 5 is so formed as to extend over the upper surface of the second electrically conductive layer 1c as well as the upper part of the inner surface facing the hollow or open portion 1a located on the side wall 1d of the base body 1. The protective metal layer 5 is formed as follows. At the outset, a masking member is placed at a predetermined location to secure a protective metal layer 5-free region. The masking member is made of stainless steel (SUS) or Fe—Ni alloy, for example. With the masking member kept in place, a sputtering or vapor deposition process is performed on the target areas.

As shown in FIG. 6, in the case of disposing the metal frame member 6, it is preferable that the protective metal layer 5 is formed also on the exposed surfaces of the metal frame member 6, namely the surfaces other than the surface joined to the second electrically conductive layer 1c in the metal frame member 6. In this case, that surfaces of the second electrically conductive layer 1c and the metal frame member 6 which are contacted by the electrolyte B-4 can be protected by the protective metal layer 5, thereby preventing the second electrically conductive layer 1c and the metal frame member 6 from dissolving into the electrolyte B-4. Accordingly, the battery B or the electric double layer capacitor B is able to deliver satisfactory performance capabilities for a longer period of time.

In this way, the first electrically conductive layer 1b and/or the second electrically conductive layer 1c can be entirely surrounded by the protective metal layer 5, and there by protected against corrosion by the electrolyte B-4.

As described heretofore, according to the invention, the container A having the battery B or the electric double layer capacitor B is mounted with top side down. That is, the battery B or the electric double layer capacitor B is mounted with its one surface illustrated as the upper surface in FIGS. 1A through 1C, FIGS. 2A through 2C, and FIGS. 3A and 3B as well as FIGS. 4 through 6 pointing downward. More specifically, the container A having the battery B or the electric double layer capacitor B is mounted, with the first electrode 2d led-out portion 2a and the second electrode 3a brought into confrontation with the electric circuit board 100. In this case, the lid body 3 and the first electrode 2d led-out portion 2a are confronted by the electric circuit board 100, and thus outwardly exposed is the opposite side (one surface of the base body 1 where no live part is provided, that is illustrated as the lower surface in FIGS. 1A through 1C, FIGS. 2A through 2c, and FIGS. 3A and 3B as well as FIGS. 4 through 6). Accordingly, at the time of mounting, for instance, an electronic component (not shown in the figure) onto the electric circuit board 100, it never occurs that an electronic component, or a wiring conductor or the like for providing electrical connection between the electronic component and the electric circuit board 100 makes contact with a live part, i.e. the first electrode 2d led-out portion 2a and the second electrode 3a, of the battery B or the electric double layer capacitor B. This makes it possible to avoid occurrence of electrical short circuit.

Moreover, in the container A thus constructed, by forming the second electrode 3a in the lid body 3, it is possible to simplify the process of manufacture of the base body 1, and thereby make the container A suitable for mass production. In addition, the lid body 3 is given a simple configuration and is thus suitable for mass production.

As has already been described, it is preferable that the first electrode 2d led-out portion 2a formed on the upper surface of the projection 2 and the second electrode 3a of the lid body 3 are arranged substantially flush with each other. In this case, as shown in FIG. 7, when the container A having the battery B or the electric double layer capacitor B is emplaced on the flat upper surface of the electric circuit board 100, with its upper surface (the surface having the first electrode 2d led-out portion 2a and the second electrode 3a) pointing downward, the first electrode 2d and the second electrode 3a, along with another electronic component, can be electrically connected to the first power source circuit wiring 101 and the second power source circuit wiring 102 of the electric circuit board 100 with ease by a surface-mounting technique.

Note that the first electrode led-out portion 2a and the second electrode 3a do not necessarily have to be arranged exactly flush with each other. That is, these two components may be arranged substantially flush with each other so long as the container A can be surface-mounted onto the electric circuit board 100 properly without causing any problem, or, for example, so long as proper electrical connection can be established with use of an electric connecting member such as solder. Even if there is a difference in surface level between the first electrode 2d led-out portion 2a and the second electrode 3a, insofar as the difference is so slight, for example as small as 0.3 mm, the first electrode 2d and the second electrode 3a can be connected readily to the first power source circuit wiring 101 and the second power source circuit wiring 102, respectively, of the electric circuit board 100 in a usual manner using solder. In this regard, by reducing the thickness of the lid body 3 to approximately 0.3 mm or below, it is possible to realize the container A of the invention without the necessity of forming the projection 2.

In a case where the first electrode 2d led-out portion 2a and the second electrode 3a are not arranged substantially flush with each other, in order to establish proper connection with the first and second power source circuit wirings 101 and 102 on the electric circuit board 100, there is interposed a connection member designed to make up for the difference in surface level.

Meanwhile, with the lid body 3 made of metal or other materials having excellent thermal conductivity, even if heat is generated in the battery element or the electric double layer capacitor element housed in the container A during operation of the battery B or the electric double layer capacitor B, the generated heat can be dissipated from the lid body 3 to the electric circuit board 100 in an efficient manner. Accordingly, the battery B or the electric double layer capacitor B is able to offer improved operability without sustaining a significant temperature rise.

Next, the battery B or the electric double layer capacitor B will be described in detail according to the invention. Referring to FIG. 7, the battery B embodying the invention is mainly composed of: the container A of the invention thus far described; the positive electrode B-1; the negative electrode B-2; and the lid body 3. The positive electrode B-1 is emplaced on the upper surface of the first electrically conductive layer 1b. The positive electrode B-1 and the first electrically conductive layer 1b are electrically connected to each other. The negative electrode B-2 is arranged in intimate contact with the upper surface of the positive electrode B-1, with the separator B-3 impregnated with the electrolyte B-4 interposed therebetween. The lid body 3, which is bonded to the upper surface of the side wall 1d of the base body 1 in such a manner as to cover the hollow or open portion 1a, is arranged in abutment with and electrically connected to the negative electrode B-2.

Note that the positive electrode B-1 and the negative electrode B-2 can be arranged in the place of each other. In this case, the negative electrode B-2 is emplaced on and electrically connected to the first electrically conductive layer 1b, whereas the positive electrode B-1 is emplaced on and electrically connected to the lid body 3.

On the other hand, referring to FIG. 7, the electric double layer capacitor B embodying the invention is mainly composed of: the container A of the invention thus far described; the first polarizable electrode B-1; the second polarizable electrode B-2; and the lid body 3. The first polarizable electrode B-1 is emplaced on the upper surface of the first electrically conductive layer 1b. The first polarizable electrode B-1 and the first electrically conductive layer 1b are electrically connected to each other. The second polarizable electrode B-2 is arranged in intimate contact with the upper surface of the first polarizable electrode B-1, with the separator B-3 impregnated with the electrolyte B-4 interposed therebetween. The lid body 3, which is bonded to the upper surface of the side wall 1d of the base body 1 in such a manner as to cover the hollow or open portion 1a, is arranged in abutment with and electrically connected to the second polarizable electrode B-2.

By virtue of the container A of the invention, the battery B or the electric double layer capacitor B can be readily connected to the electric circuit board 100 by a surface-mounting technique with high reliability in hermeticity. Moreover, impurities are hardly dissolved into the electrolyte B-4. Thus constructed, the battery B or the electric double layer capacitor B is capable of effecting charging and discharging with stability.

The positive electrode B-1 of the battery B of the invention is an electrode made in the form of a plate or a sheet which contains a cathode active material composed of LiCoO₂ or LiMnO₄ for example, and an electrically conductive material including acetylene black or black lead. On the other hand, the negative electrode B-2 is an electrode made in the form of a plate or a sheet which contains an anode active material composed of a carbon material including coke or carbon fiber.

More specifically, the positive electrode B-1 is formed as follows. At first the cathode active material and the electrically conductive material are mixed together. Then, a binder including polytetra fluoroethylene or polyvinylidene fluoride is added to the admixture to form a slurry. The slurry is shaped into a sheet-like body by a conventionally known technique including a doctor blade method or a roller molding method. Lastly, the sheet body is subjected to cutting to obtain, for example, a polygonal or circular shape.

Similarly, the negative electrode B-2 is formed as follows. At first a binder including polytetra fluoroethylene or polyvinylidene fluoride is admixed in the anode active material to form a slurry. The slurry is shaped into a sheet-like body by a conventionally known technique including a doctor blade method or a roller molding method. Lastly, the sheet body is subjected to cutting to obtain, for example, a polygonal or circular shape.

For example, the separator B-3 is formed of a nonwoven cloth made of polyolefin fiber or a polyolefin-made fine porous membrane. Following the impregnation of the separator B-3 with the electrolyte B-4, the separator B-3 is interposed between the positive electrode B-1 and the negative electrode B-2 to avoid direct contact therebetween. Moreover, the separator B-3 allows the movement of the electrolyte B-4 between the positive electrode B-1 and the negative electrode B-2, thereby allowing the passage of electric current therethrough.

For example, the electrolyte B-4 is prepared by dissolving lithium salt such as lithium borate tetrafluoride, and an acid such as hydrochloric acid, sulfuric acid, nitric acid in an organic solvent including dimethoxyethane or propylene carbonate.

The first polarizable electrode B-1 and the second polarizable electrode B-2 in the electric double layer capacitor B according to the invention are obtained by carbonizing and activating phenol resin fiber (novoloid fiber), for example, and are fabricated in a process in which the activation is carried out by causing the fiber to come in contact with an activation gas such as a high temperature steam in a high temperature atmosphere at 800 to 1000° C., and a volatile component in a carbide or a part of a carbon atom is changed into a gas, and a fine structure having a size of 1 to 10 nm is mainly developed to set an internal surface area to be 1×10⁶ m²/kg or more. In the electric double layer capacitor B according to the invention, the first and second electrodes 2a and 3a have no polarity, and the first electrode 2a side can be used as an anode and the second electrode 3a side can be used as a cathode, and they can also be used in reverse polarities.

For example, the electrolyte B-4 of the electric double layer capacitor B is prepared by dissolving lithium salt such as lithium hexafluorophosphate (LiPF₆), or quaternary ammonium salt such as tetraethyl ammonium tetrafluoroborate ((C₂H₅)₄NBF₄) in a solvent including propylene carbonate (PC) or sulfolane (SLF).

For example, the separator B-3 is formed of glass fiber or a heat-resistant porous resin material such as polyphenylene sulfide, polyethylene terephthalate, polyamide.

Following the placement of the first polarizable electrode B-1, the second polarizable electrode B-2, and the separator B-3 in the container A, the electrolyte B-4 is poured into the container A from the opening of the hollow or open portion 1a by means of a syringe, for example. Upon the completion of the charging, the lid body 3 is air-tightly welded to the upper surface of the side wall 1d in such a manner as to cover the hollow or open portion 1a. In this way, there is obtained the electric double layer capacitor B having the container A which does not permit the passage of air.

The electric double layer capacitor B thus constructed is operated by exploiting accumulation of electric charge in an electric double layer formed at the interface between the two polarizable electrodes B-1 and B-2 and the electrolyte B-4. Therefore, unless the electrolyte B-4 undergoes electrolysis at a voltage exceeding a withstand voltage, it is possible to accumulate as great electric charge a possible in correspondence with the surface area of the polarizable electrodes B-1 and B-2.

The feature of the electric double layer capacitor B is especially advantageous if it employs an organic solution. In this case, it is possible to obtain a driving voltage 2 to 4 times as large as in the electric double layer capacitor B which employs an aqueous solution such as a sulfuric acid solution as the electrolyte. The maximum permissible accumulation of electric energy E is given by the formula: E=CV²/2, wherein V represents voltage and C represents capacitance. It will thus be seen that the electric double layer capacitor B is capable of providing high energy density.

The electrolyte B-4 of the battery B or the electric double layer capacitor B is essentially highly corrosive and soluble. In this regard, according to the container A of the invention, the base body 1 is impervious to the electrolyte B-4 which contains an organic solvent, an acid, etc. Moreover, it never occurs that impurities eluted from the container A find their way into the electrolyte B-4, wherefore the electrolyte B-4 is free from quality degradation. Accordingly, the battery performance can be maintained at a satisfactory level.

Moreover, according to the container A of the invention, the battery B or the electric double layer capacitor B is surface-mountable in such a manner that the first electrode 2d led-out portion 2a and the second electrode 3a are disposed on a side facing the surface of the electric circuit board 100 so that the first electrode 2d led-out portion 2a and the second electrode 3a face the electric circuit board 100. In this case, the surface having the first electrode 2d and the second electrode 3a can be electrically connected readily to the first power source circuit wiring 101 and the second power source circuit wiring 102 disposed on the electric circuit board 100. This makes it possible to reduce a size of the power source circuit disposed on the electric circuit board 100. Moreover, the battery B or the electric double layer capacitor B can be surface-mounted onto the electric circuit board 100 together with another electronic component, which results in an electronic device exhibiting high productivity. Further, the battery B or the electric double layer capacitor B can be placed in the vicinity of the electronic component, wherefore the electronic component is able to exhibit enhanced responsiveness.

While the invention has been shown in several forms by way of embodiments, it is not so limited but is susceptible of various changes and modifications without departing from the spirit and scope of the claimed invention. For example, although the above description deals with the case where the container A used for the battery B or the electric double layer capacitor B is provided with a single hollow or open portion 1a, the container A may be provided with a plurality of concavities 1a. In this case, it is possible to provide either a single lid body 3 for covering the concavities 1a as a whole or a plurality of lid bodies 3 for covering the concavities 1a on an individual basis. In the container A having a plurality of concavities 1a, by connecting the batteries B or the electric double layer capacitors B arranged in the concavities 1a in parallel with one another, it is possible to achieve high-capacitance characteristics. Alternatively, by connecting them in series with one another, it is possible to allow the battery B to provide a high voltage.

Note that, in the above description, the words such as “upper”, “lower”, “side”, “bottom” are used solely for the purpose of illustrating the embodiments of the invention with reference to the accompanying drawings, and therefore they do not stand for any positional relationship of the constituent components in actual use of the invention.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A container comprising:
a base body constituted of a side wall and a bottom portion, having a hollow or open portion for housing therein an electrical storage element;
an electrically conductive layer disposed on a bottom surface of the bottom portion facing the hollow or open portion;
a first electrode electrically connected to the electrically conductive layer, having a first electrode led-out portion which is led out to an upper surface of the side wall of the base body; and
a lid body having a second electrode formed on its upper surface and an electrically conductive portion formed on its lower surface, the second electrode and the electrically conductive portion being electrically connected to each other,
wherein the lid body is bonded to the upper surface of the side wall of the base body in such a manner as to cover the hollow or open portion.

2. The container of claim 1, wherein the first electrode led-out portion is substantially flush with the second electrode.

3. The container of claim 1, wherein the first electrode led-out portion is disposed on an upper surface of a projection formed on the upper surface of the side wall of the base body so as to lie in juxtaposition with an opening of the hollow or open portion.

4. The container of claim 1, wherein the first electrode is connected to the electrically conductive layer by way of a through conductor formed inside the base body with its one end extended to the bottom surface facing the hollow or open portion.

5. The container of claim 4, wherein the junction between the first electrode and the through conductor is located at some midpoint between the bottom surface facing the hollow or open portion and the lower surface of the base body in the inside of the base body.

6. A battery comprising:
a base body constituted of a side wall and a bottom portion, having a hollow or open portion;
an electrically conductive layer disposed on a bottom surface of the bottom portion facing the hollow or open portion;
a first electrode electrically connected to the electrically conductive layer, having a first electrode led-out portion which is led out to an upper surface of the side wall of the base body;
an electrical storage element housed in the hollow or open portion, composed of a positive electrode, a negative electrode, a separator interposed between the positive electrode and the negative electrode, and an electrolyte; and
a lid body having a second electrode formed on its upper surface, the lid body being bonded to the upper surface of the side wall of the base body in such a manner as to cover the hollow or open portion,
wherein one of the positive electrode and the negative electrode is electrically connected to the electrically conductive layer, and the other of the positive electrode and the negative electrode is electrically connected to an electrically conductive portion formed on a lower surface of the lid body.

7. The battery of claim 6, wherein the first electrode led-out portion is substantially flush with the second electrode.

8. The battery of claim 6, wherein the first electrode led-out portion is disposed on an upper surface of a projection formed on the upper surface of the side wall of the base body so as to lie in juxtaposition with an opening of the hollow or open portion.

9. The battery of claim 6, wherein the first electrode is connected to the electrically conductive layer by way of a through conductor formed inside the base body with its one end extended to the bottom surface facing the hollow or open portion.

10. The battery of claim 9, wherein the junction between the first electrode and the through conductor is located at some midpoint between the bottom surface facing the hollow or open portion and the lower surface of the base body in the inside of the base body.

11. An electric double layer capacitor comprising:
a base body constituted of a side wall and a bottom portion, having a hollow or open portion;
an electrically conductive layer disposed on a bottom surface of the bottom portion which bottom surface faces the hollow or open portion;
a first electrode electrically connected to the electrically conductive layer, having a first electrode led-out portion which is led out to the upper surface of the side wall of the base body;
an electrical storage element housed in the hollow or open portion, composed of a first polarizable electrode, a second polarizable electrode, a separator interposed between the first polarizable electrode and the second polarizable electrode, and an electrolyte; and
a lid body having a second electrode formed on its upper surface, the lid body being bonded to the upper surface of the side wall of the base body in such a manner as to cover the hollow or open portion,
wherein one of the first polarizable electrode and the second polarizable electrode is electrically connected to the electrically conductive layer, and the other of the first polarizable electrode and the second polarizable electrode is electrically connected to an electrically conductive portion formed on a lower surface of the lid body.

12. The electric double layer capacitor of claim 11, wherein the first electrode led-out portion is substantially flush with the second electrode.

13. The electric double layer capacitor of claim 11, wherein the first electrode led-out portion is disposed on an upper surface of a projection formed on the upper surface of the side wall of the base body so as to lie in juxtaposition with an opening of the hollow or open portion.

14. The electric double layer capacitor of claim 11, wherein the first electrode is connected to the electrically conductive layer by way of a through conductor formed inside the base body with its one end extended to the bottom surface facing the hollow or open portion.

15. The electric double layer capacitor of claim 14, wherein the junction between the first electrode and the through conductor is located at some midpoint between the bottom surface facing the hollow or open portion and the lower surface of the base body in the inside of the base body.

16. An electronic device comprising:
a wiring substrate having a power source circuit wiring; and
the battery of claim 6, which is mounted onto the wiring substrate,
wherein the first electrode of the container and the second electrode formed on the upper surface of the lid body are connected, so as to face the wiring substrate, to the power source circuit wiring through an electrically conductive.

17. An electronic device comprising:
a wiring substrate having a power source circuit wiring; and
the electric double layer capacitor of claim 11, which is mounted onto the wiring substrate,
wherein the first electrode of the container and the second electrode formed on the upper surface of the lid body are connected, so as to face the wiring substrate, to the power source circuit wiring through an electrically conductive material.
